(19) United States
(12) Patent Application Publication
(10) Pub. No.: US 2009/0256020 A1
(43) Pub. Date: Oct. 15, 2009

(54) Shredder Blades And Methods For Producing Shredder Blades And/Or Shredder Blade Pairs

(75) Inventors: Charles Sued, Brooklyn, NY (US); Aron Abramson, Brooklyn, NY (US); Shen Tao Ou, Tai Chung County (TW)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignees: Charles Sued; Aron Abramson

(21) Appl. No.: 12/102,957

(22) Filed: Apr. 15, 2008

(51) Int. Cl. B02C 7/12; B21K 5/12

(52) U.S. Cl. 241/297; 76/115

(57) ABSTRACT

A method of manufacturing shredder blades which improves efficiency and a new structure for a shredder blade or blade pair.

### BACKGROUND

The present invention is generally directed to shredders and, more specifically, to shredder blades and to methods of producing shredder blades in which fabrication of shredder blades and assembly into shredder blade pairs is performed in a single manufacturing stage.

The normal operation of a shredder generally entails directing material to be shredded between two sets of shredder blades arranged along two parallel axles. The shredder blades along opposite axles are interlaced with overlapping radii, and a cutting surface is formed at the interface of the two opposing sets of blades. There are two types of shredders, strip-cut shredders and cross-cut shredders. A strip-cut shredder divides the shredded material into long strips, and requires blades of a generally round shape. A cross-cut shredder also cuts the shredded material laterally to separate the shredded material into strips of shorter length. A cross-cut shredder generally places greater stress on the shredder blades and the shredder axle which may result in some conventional shredder blades deforming and malfunctioning.

Manufacturing the shredder blades generally involves cutting each blade into the preferred shape. The width of each conventional blade is generally equal to the thickness of the sheet metal. Spacers may be located along each shredder axle to provide distance between adjacent blades to allow interlacing of blades on opposing axles.

It may be advantageous to manufacture a shredder blade having an improved configuration for use in a shredder or to manufacture shredder blade pairs that have sufficient structural rigidity, that can be manufactured at a reduced cost, and/or that can be manufactured as part of a running manufacturing process.

### SUMMARY

Briefly speaking, the present invention is directed to a method of producing shredder blades during assembly of a shredder. Sheet metal is sent into a processing station and moves continuously through the station. While the sheet metal is moving through the station, it is stamped to form first and second shredder blades. The first and second shredder blades continue to move through the processing station and are riveted together to form a blade pair adapted for use in a shredder. This processing station is part of a continuously running manufacturing process for producing a plurality of blade pairs from sheet metal.

In another aspect, the invention is directed to a blade pair adapted for use in a shredder. Each of the first and second blades of the blade pair has a major mating surface, a sidewall extending generally outward from the major mating surface, and a plurality of cutting teeth. In the assembled blade pair, the cutting teeth of the first and second blades are aligned, and the inner surfaces of adjacent teeth form an angle of between eighty (80) degrees to ninety (90) degrees.

In another aspect, the invention is directed to a method of producing shredder blades during assembly of a shredder. Sheet metal is sent into a processing station and moves continuously through the station. While the sheet metal is moving through the station, it is stamped to form first and second shredder blades. Each of the first and second blades of the blade pair has a major mating surface, a sidewall extending generally outward from the major mating surface, and a plurality of cutting teeth. The first and second shredder blades continue to move through the processing station and are riveted together to form a blade pair adapted for use in a shredder. In the assembled blade pair, the cutting teeth of the first and second blades are aligned, and the inner surfaces of adjacent teeth form an angle of between eighty (80) degrees to ninety (90) degrees. This processing station is part of a continuously running manufacturing process for producing a plurality of blade pairs from sheet metal.

In a separate aspect, the invention is directed to a method of producing shredder blades during assembly of a shredder. Sheet metal is sent into a processing station and moves continuously through the station. While the sheet metal is moving through the station, it is stamped to form first and second shredder blades. Each of the first and second blades of the blade pairs have a major mating surface, a sidewall extending generally outward from the major mating surface, and a plurality of cutting teeth. The first shredder blade is stamped with a plurality of tubes that extend past the major mating surface of the blade and are configured to serve as a rivet. The second shredder blade is stamped with a plurality of bores on the major mating surface which accommodate the tubes of the first blade. The first and second shredder blades continue to move through the processing station and in a continuous process the tubes of the first shredder blade are inserted into the bores of the second blade and are bent to rivet the first and second blades together. In the assembled blade pair, the cutting teeth of the first and second blades are aligned, and the inner surfaces of adjacent teeth form an angle of between eighty (80) degrees to ninety (90) degrees. This processing station is part of a continuously running manufacturing process for producing a plurality of blade pairs from sheet metal.

In another aspect, one embodiment of the present invention is directed toward a method of producing shredder blades, including: transporting material through a first processing station in a continuous fashion; while the material is moving through the first processing station, forming at least a portion of the material to generate first and second shredder blades from the material; and while the first and second shredder blades are moving through the first processing station, joining the first and second shredder blades together to form a blade pair adapted for use in a shredder, wherein the forming and joining both occur in the first processing station to allow first and second shredder blades to be formed from material and joined together to form the blade pair as part of a continuously running manufacturing process for producing a plurality of blade pairs from material.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of an exemplary shredder that incorporates shredder blades according to a preferred embodiment of the present invention; a plurality of shredder blade pairs may be located along two parallel shredder axles and are preferably oriented such that material inserted into one of the two slots passes between the two shredder axles and is shredded by the rotating movement of the plurality of shredder blade pairs;

FIG. 2 is a perspective view of preferred first and second shredder blades which can be joined (via riveting or the like) to form a blade pair and are preferably incorporated into a shredder or stored for later use; the dashed line shows the path along which the shredder blades are moved during assembly;

FIG. 3 is a perspective view of the two shredder blades which can be riveted to form a blade pair and incorporated into a shredder; each tube of the first blade may be inserted into a matching bore of the second blade to orient the major mating surface of the first shredder blade adjacent to the major mating surface of the second shredder blade;

FIG. 4 is a perspective view of the assembled blade pair which may be incorporated into a shredder; each tube of the first blade may be bent to form a rivet which holds the two blades together;

FIG. 5 is a perspective view of a plurality of shredder blade pairs in their location along the two parallel shredder axles in the shredder of FIG. 1; the shredder blades are interlaced and each cutting surface of a shredder blade pair is matched with the cutting surface of a shredder blade pair on the opposite axle;

FIG. 6 is a top plan view of a portion of the interface between shredder blade pairs on opposite shredder axles in the shredder of FIG. 1; the figure illustrates spacers which keep the blades on each axle in an optimal interlaced position;

FIG. 7 is a perspective view of a part of a preferred first processing station according to a preferred embodiment of the present invention; the sheet metal travels left to right across the figure, and the following sequence of processing steps preferably occurs; First, the outline of each of the two blades is stamped into the sheet metal; Then the metal of each blade is punched and stamped to form shredder axle holes, tubes, and/or bores, depending on the shredder blade being processed; Then, each of the two blades is punched out of the sheet metal and drops into its receiving mold block;

FIG. 8 is a perspective view of a part of the preferred first processing station of FIG. 7; the mold blocks preferably, but not necessarily, move left to right across the figure and rotate to place the first shredder blade on an anvil and the second shredder blade on an arbor;

FIG. 9 is a perspective view of a part of the preferred first processing station of FIG. 7; the anvil and arbor bring the first and second blades together, and the tubes of the first blade are inserted into the bores of the second blade and bent to rivet the first and second blades together; the arbor is removed to leave the riveted blade pair on the anvil, which then advances the blade pair onto a mandrel or any other suitable receptacle; the mandrel may hold the blade pair to allow a pair of grinding wheels to grind the blade pair to the correct width or sharpen the blade edges;

FIG. 10 is a cross-sectional view of the anvil, arbor and first and second shredder blades of FIG. 8 as taken along the line 10-10 in FIG. 8; one of the tubes of the first shredder blade is shown in cross section, as are the corresponding bore in the second shredder blade and the portion of the arbor which bends the tube into a rivet;

FIG. 11 is a cross-sectional view of the anvil, arbor and joined shredder blade pair of FIG. 9 as taken along the line 11-11 in FIG. 9; one of the tubes of the first shredder blade is shown in cross section, and it extends through the corresponding bore in the second shredder blade and has been bent by the arbor into a rivet which joins the blades together;

FIG. 12 is a flowchart of one preferred method for producing shredder blade (or cutter) pairs in the processing station of FIGS. 7-11 or using any other suitable processing arrangement; the shredder blades are moved from the mandrel to the shredder axle (or drive axle) in a step outside the processing station shown in these figures; and

FIG. 13 is a flowchart of another preferred method for producing shredder blade pairs and mounting them onto the shredder axle according to another preferred embodiment of the present invention; in this embodiment, the anvil advances the blade pair directly onto the shredder axle.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “inwardly” and “outwardly” refer to directions toward and away from, respectively, the geometric center of the shredder and designated parts thereof. The term “selectable control”, as used in the claims and the corresponding portions of the specification, means “any one of a physical switch, a touch switch, a button, a voice activated switch, a control knob, a remote control switch, or any other known operating mode selection device”. The term “activated state”, as used with selectable control, means that the selectable control has been manipulated so that the selectable control is set for a particular function. For example, if the selectable control is a simple switch, then the activated state may be having the switch turned to another position and if the selectable control is a touch sensor, then the activated state may be initiated by depressing or touching the sensor in a predetermined manner. The language “at least one of ‘A’, ‘B’, and ‘C’,” as used in the claims and in corresponding portions of the specification, means “any group having at least one ‘A’; or any group having at least one ‘B’; or any group having at least one ‘C’;—and does require that a group have at least one of each of ‘A’, ‘B’, and ‘C’.” Additionally, the words “a” and “one” are defined as including one or more of the referenced item unless specifically stated otherwise. The terminology includes the words above specifically mentioned, derivatives thereof, and words of similar import.

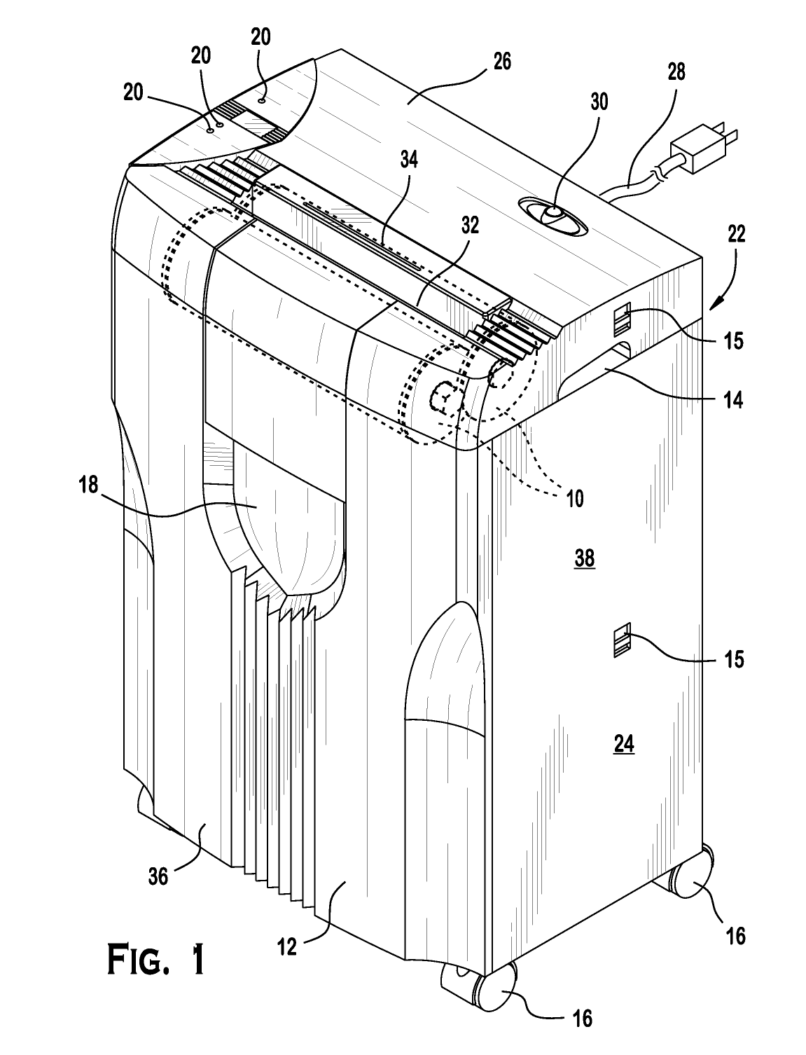

Referring to FIGS. 1-13, wherein like numerals indicate like elements throughout, there are shown preferred embodiments of improved shredder blades 40A, 40B and methods of producing shredder blades that improve the manufacturing process. While the methods are preferably used with the improved shredder blades 40A, 40B, they can be used to manufacture blades of any configuration without departing from the scope of the present invention.

Referring to FIG. 1, one exemplary shredder 22 is shown. The shredder 22 includes a shredder head 26 which defines at least one slot 32, 34 that is adapted to receive material to be shredded. The shredder head 26 is incorporated into a shredder housing 24 with lateral sides 38, and a basket 12 is removeably positioned in the shredder housing 26 for collection of shredded material and comprises the greater part of the front 36 of the shredder 22. The basket includes a transparent section 18 which allows a user to visually determine when the bin must be emptied for continued optimal shredder operation. Wheels 16 located at the bottom of the shredder housing 24 allow the shredder to be rolled into a desired location, and handles 14 allow the shredder to be moved vertically over obstacles in the rolling path. While one preferred configuration for a shredder incorporating blades of the present invention has been shown and described, those of ordinary skill in the art will appreciate that the blades 40A, 40B of the present invention and the methods of producing blades of the present invention can be used with any suitable shredder or to just manufacture shredder blades that may later be incorporated into a shredder.

The shredder may be powered by an electrical connection/power conduit 28, and when electrical power is delivered to the shredder a selectable control 30 on the shredder head allows a user to set the shredder to either operate continuously or activate when material is placed into one of the slots 32, 34. Indicators 20 on the shredder head alert a user to any condition that would interfere with continued shredder operation such as an overloaded bin or an automatic reverse in progress. Additional controls 15 allow the user to make adjustments to shredder performance appropriate to the material to be shredded. A plurality of shredder blades 10 are disposed within the shredder head 26 and are adapted to shred the material inserted into one of the slots 32, 34 and eject it into the basket 12. The first slot 32 is preferably used for paper documents and the second slot 34 is preferably used for more rigid documents, such as credit cards, compact discs, etc.

The shredder housing 24 and basket 12 of the present invention are preferably constructed of a polymer for maximum rigidity. However, the shredder can be constructed of any suitable material without departing from the scope of the present invention.

Referring still to FIG. 1, while the preferred shredder 22 has a generally rectilinear shape, those of ordinary skill in the art will appreciate from this disclosure that the shredder 22 can have any shape without departing from the scope of the present invention. The top and/or side surfaces of the shredder may also include other operational indicators 15. While one exemplary shredder has been described in conjunction with FIG. 1, those of ordinary skill in the art will appreciate from this disclosure that the present invention can be practiced with shredders of any configuration without departing from the scope of the present invention.

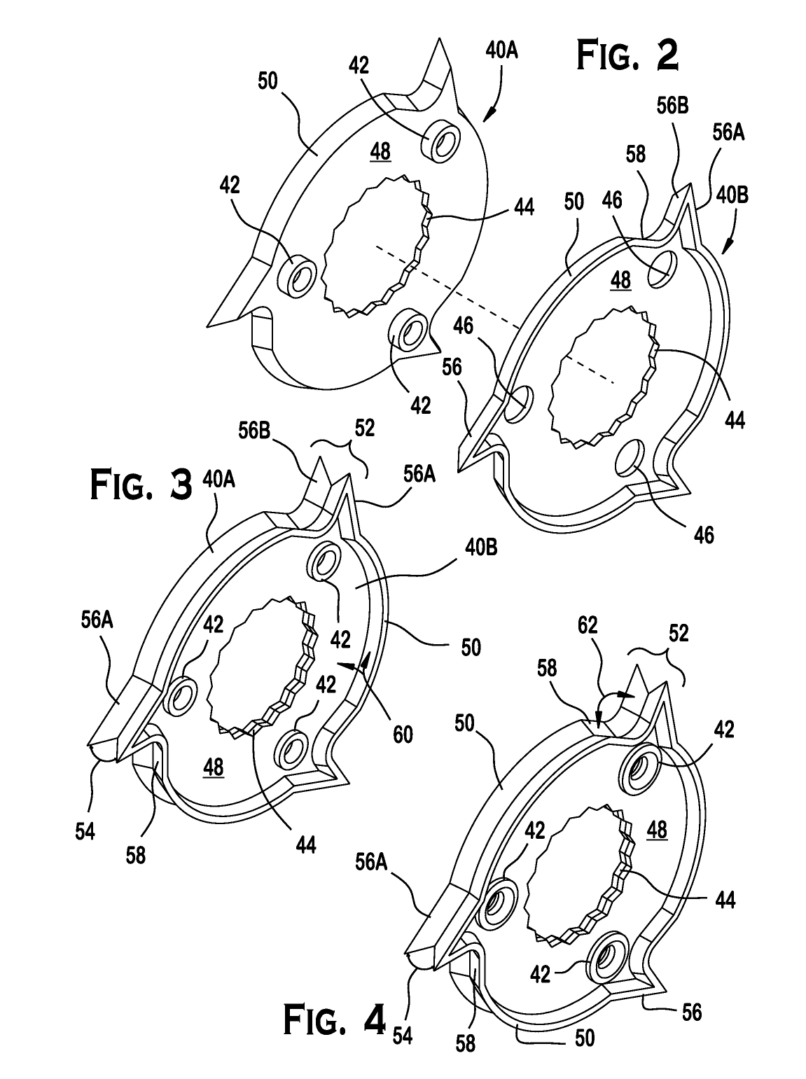

Referring to FIG. 2, each of the first shredder blade 40A and the second shredder blade 40B may have a shredder axle bore 44, a major mating surface 48, a sidewall 50 extending generally outwardly therefrom, and three cutting teeth 56 with first cutting surface 56A and second cutting surface 56B. The number of cutting teeth 56 may vary without departing from the scope of the present invention. Each cutting tooth 56 extends from a flat 58 and the second cutting surface 56B is adjacent to the flat 58 along the sidewall 50. The sidewall 50 and the major mating surface 48 preferably form an angle 60 of between one hundred (100) degrees and one hundred twenty (120) degrees. It is more preferred that the angle between the sidewall and the major mating surface form an angle 60 of approximately one hundred ten and a half (110.5) degrees. It is preferred that the height of the sidewall 50 is between one (1) millimeter and one and a half (1.5) millimeters. It is more preferred that the height of the sidewall 50 is approximately one point three (1.3) millimeters. The first shredder blade 40A includes three tubes 42, and the second shredder blade 40B includes three bores 46 which are of the same diameter as the outside surface of the tubes 42 of the first shredder blade 40A. Each of the tubes 42 and the bores 46 are preferably located inwardly from one of the three cutting teeth 56. The number of tubes 42 and bores 46 may vary without departing from the scope of the present invention. The cutting tooth 46 and flat 58 preferably form an angle 62 of between eighty (80) and one hundred (100) degrees. It is more preferred that the cutting tooth 46 and flat 58 form an angle 62 of approximately ninety (90) degrees. The angle formed by the sidewall 50 at the end of the cutting tooth is preferably between thirty-five (35) and forty-five (45) degrees. It is more preferred that the angle formed by the sidewall 50 at the end of the cutting tooth is approximately forty (40) degrees.

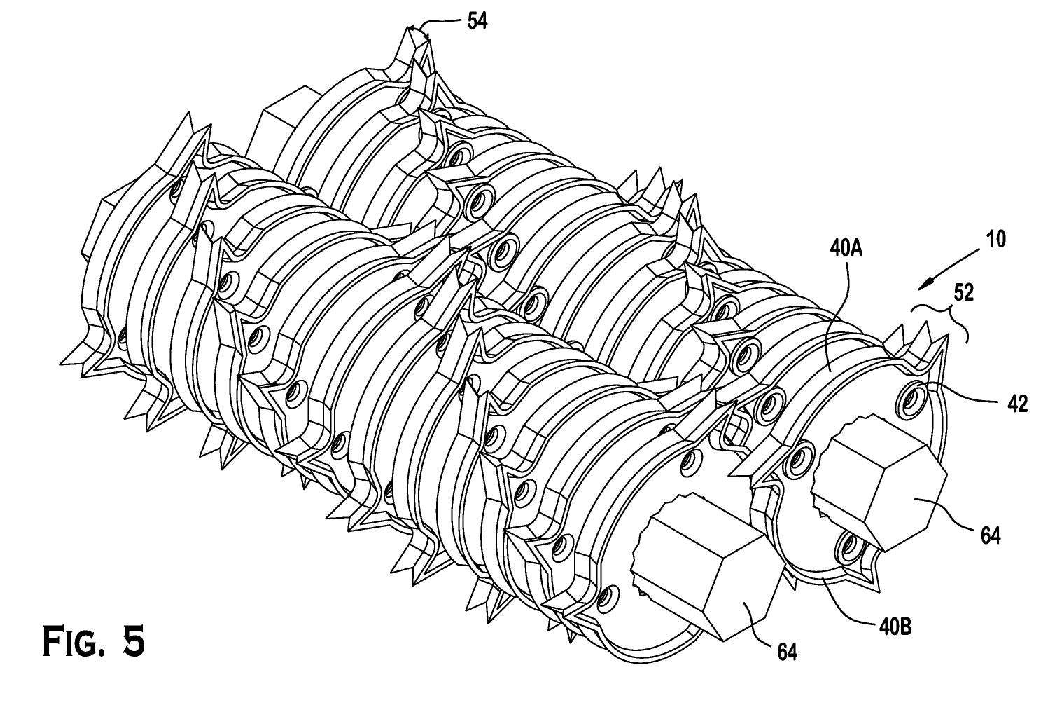

Referring to FIG. 3, the first and second shredder blades 40A, 40B are brought into contact to form a blade pair 52. Each tube 42 of the first shredder blade 40A extends through a bore of the second shredder blade 40B, and the entire major mating surface 48 of the first shredder blade 40A is preferably in contact with the entire major mating surface 48 of the second shredder blade 40B. In this position, the shredder axle bore 44 on the first shredder blade 40A is aligned with the shredder axle bore 44 on the second shredder blade 40B. The angle 54 formed by the sidewalls 50 at the end of each cutting tooth 56 is preferably between eighty (80) and ninety (90) degrees. It is more preferred that the angle 54 formed by the sidewalls 50 at the end of each cutting tooth 56 is approximately eighty-six (86) degrees.

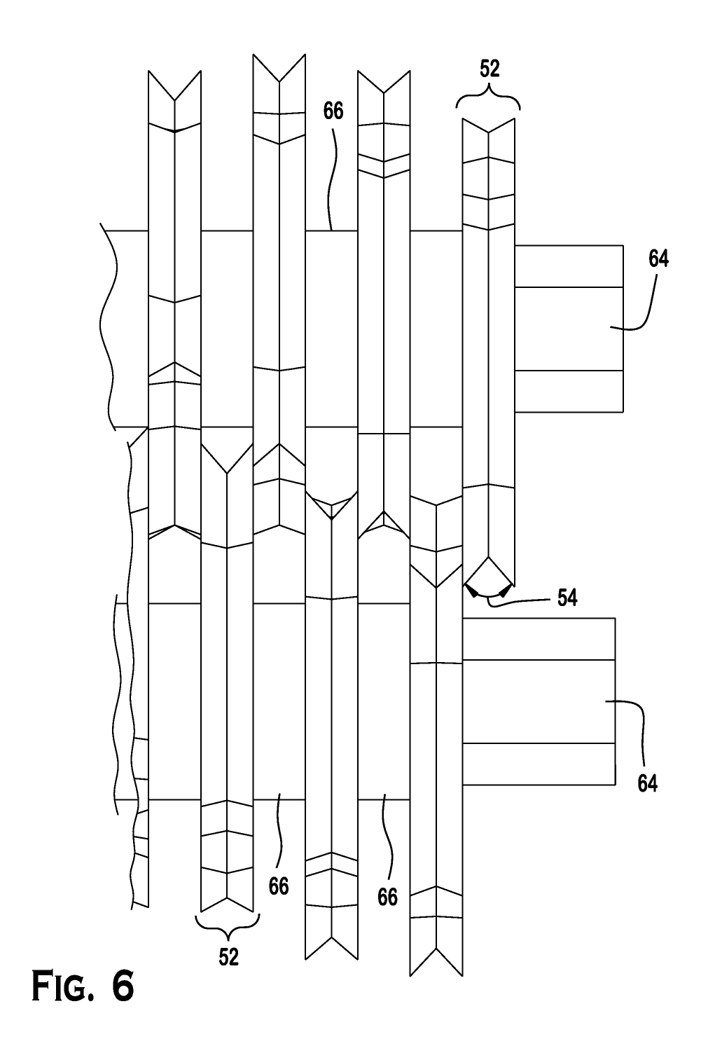

Referring to FIG. 4, each tube 42 of the first shredder blade 40A is bent to form a rivet about the bore 46 of the second shredder blade 40A. In the riveted configuration, it is preferred that the blade pair 52 has a width between one point five (1.5) and five (5) millimeters. It is more preferred that the blade pair 52 has a width between two (2) and three (3) millimeters. It is still more preferred that the blade pair 52 has a width of approximately two point six (2.6) millimeters.

While it is preferred that the shredder blades 40A, 40B are riveted together, any suitable joining method (such as welding) can be used without departing from the scope of the present invention. Furthermore, although a preferred shredder blade structure has been described, the methods of the present invention can be used to form shredder blades having any configuration without departing from the scope of the present invention. Furthermore, the method of the present invention can be used to join together three or more shredder blades to form a blade pair 52.

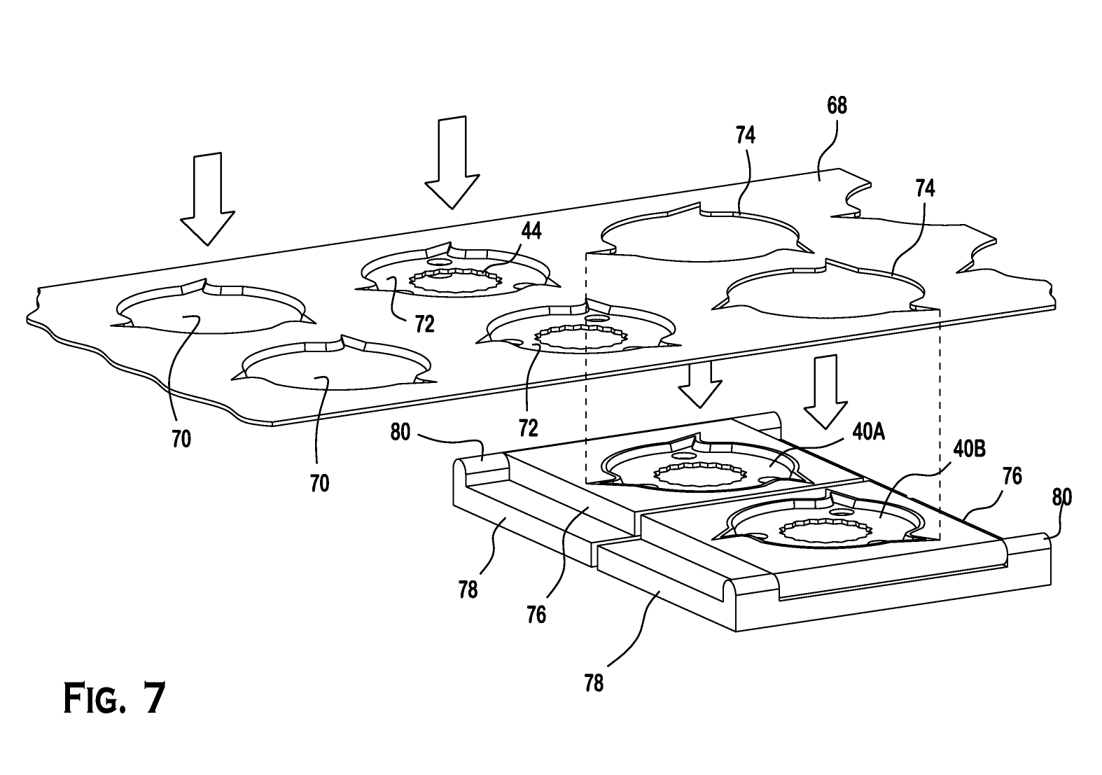

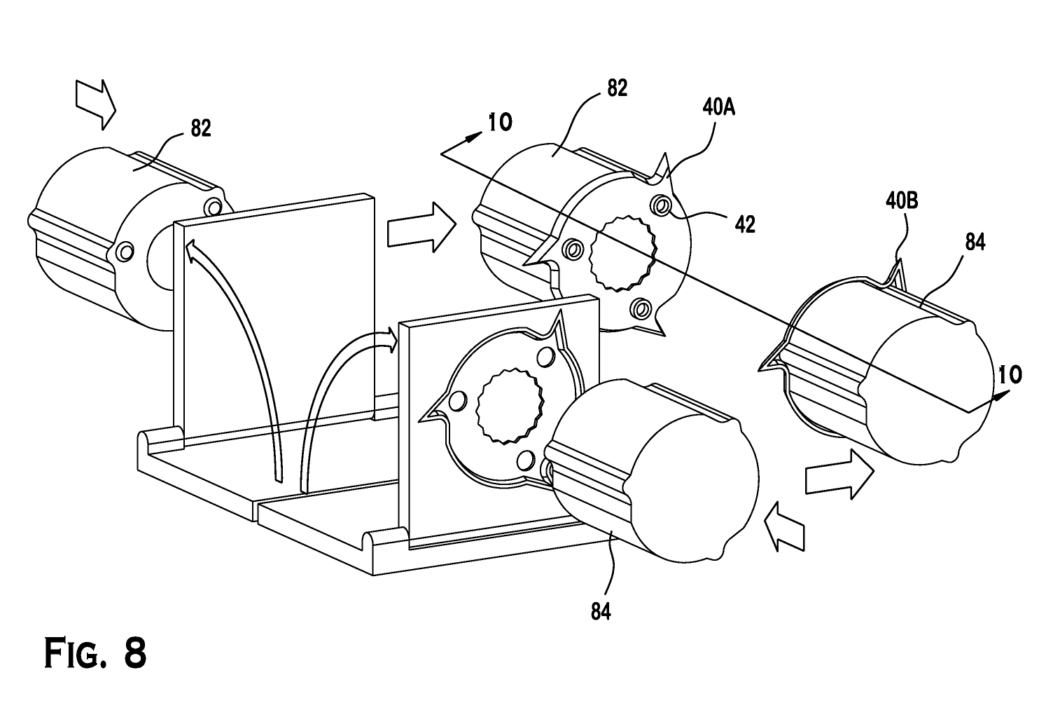

Referring to FIGS. 5 and 6, each blade pair 52 is located along one of the two shredder axles 64, with the shredder axle 64 passing through the shredder axle hole 44 of each blade pair 52. Each blade pair 52 is separated along the axle 64 from its adjacent blade pairs by a spacer 66. Along each shredder axle 64, the spacers 66 position the blade pairs 52 such that they are interlaced with the blade pairs 52 on the opposite axle. On each blade pair 52, the first cutting surface 56A of each cutting tooth 56 is matched with the first cutting surface 56A of a blade pair 52 on the opposite axle.

Referring to FIGS. 7-11, wherein like numerals indicate like elements throughout, there are shown a preferred embodiment of a preferred blade pair processing station. It is preferred that this station both forms the shredder blades 40A, 40B and assembles them into a blade pair. Briefly speaking, the blade pair assembly station takes in sheet metal 68 and produces assembled blade pairs 52 which are placed on a mandrel 64B (or placed in/on any suitable collection mechanism or container) and possibly ground to the correct width by grinding wheels 86. While it is preferred to use sheet metal 68, those of ordinary skill in the art will appreciate from this disclosure that any suitable material can be used to form the shredder blades 40A, 40B without departing from the scope of the present invention.

Referring to FIG. 7, the sheet metal 68 travels generally continuously left to right across the figure. In the preferred sequence, the shape of each of the two shredder blades 40A, 40B is stamped into the sheet metal 68, defining the major mating surface 48 and the sidewalls 50 on each shredder blade. As the sheet metal 68 continues left to right, the shape of the left shredder blade 40A is punched to form a shredder axle hole 44 and is stamped to form three tubes 42 which will function as rivets in the finished shredder blade pair. The shape of the right shredder blade 40B is punched to form a shredder axle hole 44 and three bores 46 which match the three tubes 42. Each of the two shredder blades 40A, 40B is punched out of the sheet metal 68 and drops into its receiving mold block 76. The receiving mold block 76 is attached to the base 78 at a pivot 80.

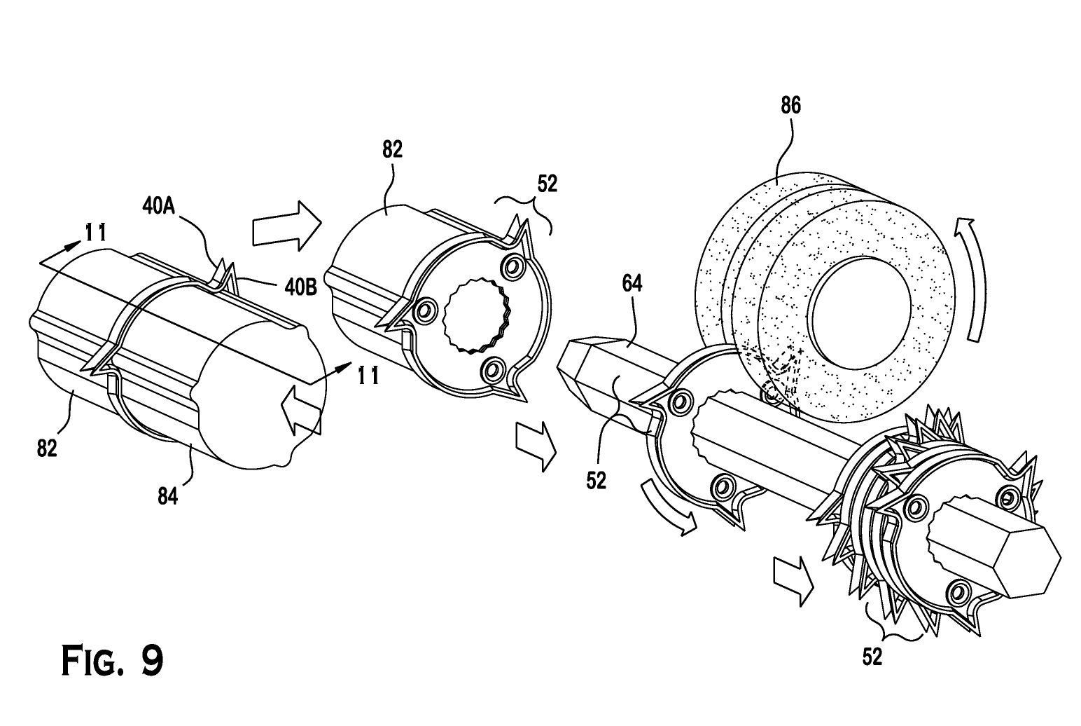

Referring to FIG. 8, the base 78 preferably moves generally continuously left to right across the figure to allow the shredder blades 40A, 40B to move along the same general path as the sheet metal if desired. Each of the receiving mold blocks 76 rotates about the pivot 80 to a vertical orientation. The anvil 82 and arbor 84 move generally continuously left to right across the figure, and when the receiving mold blocks 76 reach a vertical orientation, the first shredder blade 40A is put onto the anvil 82, and the second shredder blade 40B is put onto the arbor 84. The receiving mold blocks 76 then return to a horizontal position leaving a clear path between the anvil 82 and arbor 84.

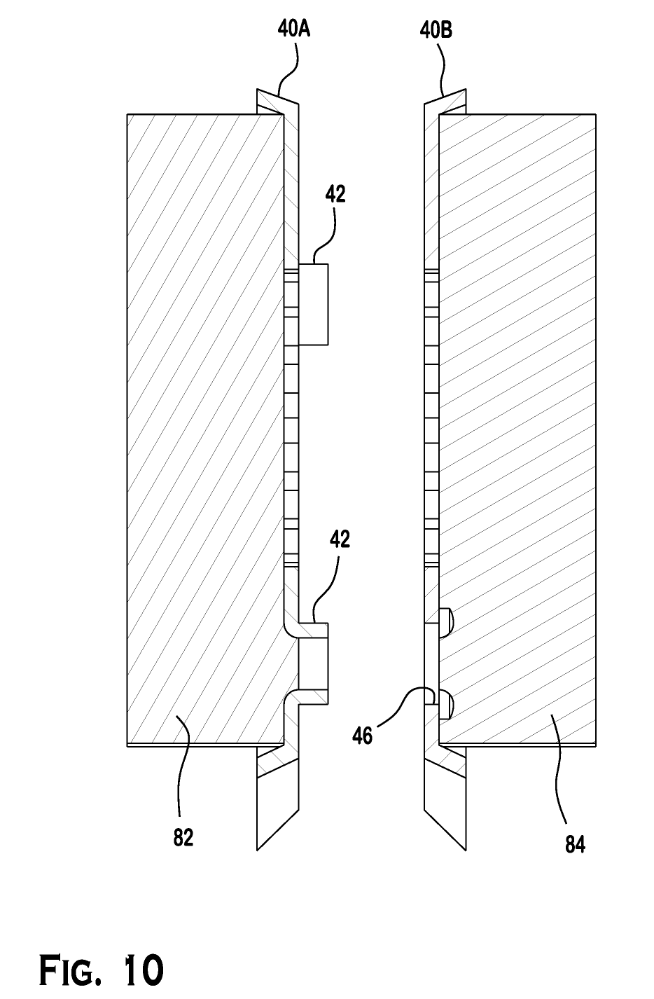

Referring to FIG. 9, the anvil 82 and arbor 84 move generally continuously left to right across the figure. The arbor 84 moves towards the anvil 82 and presses the major mating surface 48 of the second shredder blade 40B against the major mating surface 48 of the first shredder blade 40A. Each of the three tubes 42 of the first shredder blade 40A extends through one of the three bores 46 in the second shredder blade 40B. The arbor 84 is adapted to bend the tubes 42 to form rivets which hold the blade pairs together. After the rivets are formed, the arbor 84 withdraws from the anvil 82, and the anvil carries the riveted blade pair 52 onto the mandrel 64B. Once the blade pair 52 is in position on the mandrel 64B, a pair of grinding wheels 86 may engage the blade pair 52 and rotate to grind the blade pair 52 to the required width and sharpen the first cutting surface 56A of each tooth. As the grinding wheels 86 turn, the mandrel 64B also turns to bring the entire perimeter of the blade pair to the grinding wheels 86. When grinding is complete, the blade pair may be moved towards the end of the mandrel 64B to await placement onto the shredder axle 64A.

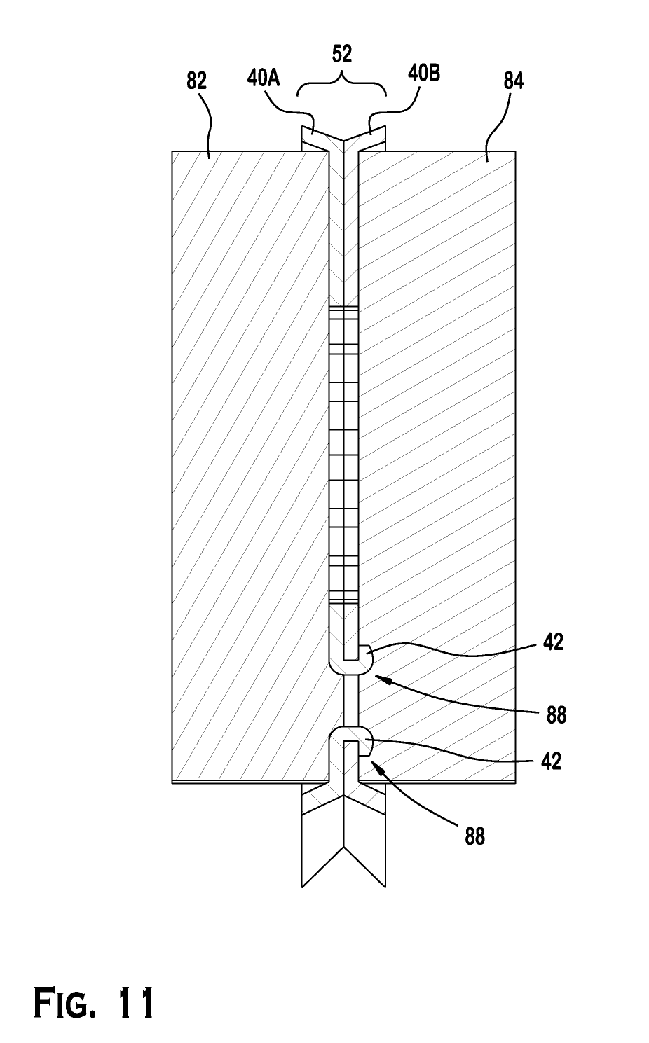

Referring to FIG. 10, the anvil 82 holds the first shredder blade 40A, and the arbor 84 holds the second shredder blade 40B as shown in FIG. 8. The tubes 42 extend from the major mating surface 48 of the first shredder blade 40A. The bores 46 are of the same diameter as the external diameter of the tubes 42, and the arbor 84 includes a hollowed area which accommodates the tubes 42 as they extend past the bore 46 in the second shredder blade 42B.

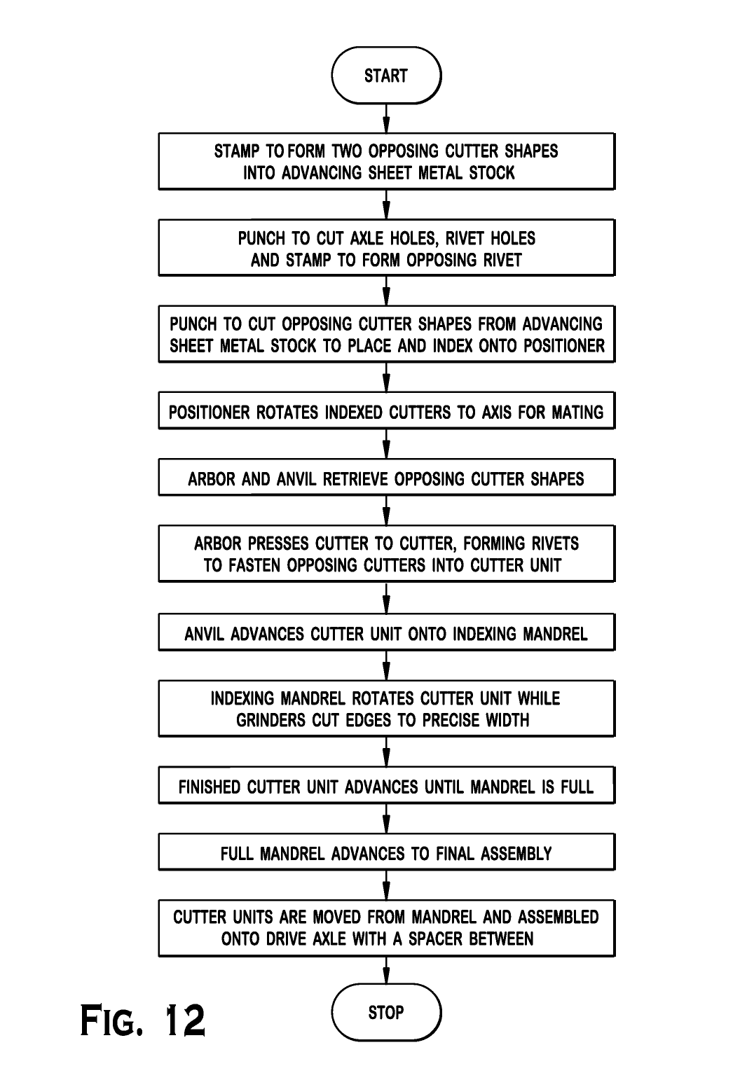

Referring to FIG. 11, the arbor 84 presses the second shredder blade 40B against the first shredder blade 40A as shown in FIG. 9. The tubes 42 extend past the bore 46 into a hollowed area of the arbor 84, and are bent into a rivet that joins the first and second shredder blades 40A, 40B into a shredder blade pair 52.

Multiple preferred methods of the present invention will be described below (alone or in combination with various embodiments of the shredder blades). The steps of the methods of the present invention can be performed in any order, omitted, or combined without departing from the scope of the present invention. As such, optional or required steps described in conjunction with one method can also be used with another method or omitted altogether. Additionally, unless otherwise stated, similar structure or functions described in conjunction with one method preferably, but not necessarily, operate in a generally similar manner to that described elsewhere in this application.

One preferred method of producing shredder blades 40A, 40B includes transporting sheet metal 68 through a processing station. While the sheet metal 68 is moving through the station, it is stamped to form first and second shredder blades 40A, 40B. The first and second shredder blades 40A, 40,B continue to move through the processing station and are riveted (or otherwise secured) together to form a blade pair adapted for use in a shredder. This processing station is part of a continuously running manufacturing process for producing a plurality of blade pairs from sheet metal.

Another preferred method of the present invention is directed to a method of producing shredder blades 40A, 40B including the steps of: transporting sheet metal 68 through a first processing station in a generally continuous fashion. While the sheet metal 68 is moving through the first processing station, stamping the sheet metal 68 to form first and second shredder blades 40A, 40B from the sheet metal 68. While the first and second shredder blades 40A, 40B are moving through the first processing station, riveting (or otherwise joining) the first and second shredder blades 40A, 40B together to form a blade pair 52 adapted for use in a shredder. Wherein the stamping and riveting both occur in the first processing station to allow first and second shredder blades 40A, 40B to be stamped from sheet metal and riveted together to form the blade pair 52 as part of a generally continuously running manufacturing process for producing a plurality of blade pairs 52 from sheet metal 68.

Another preferred method of the present invention is directed to making a blade pair 52 adapted for use with a shredder including first and second shredder blades 40A, 40B each having a major mating surface 48, a sidewall 50 extends generally outwardly therefrom, and a plurality of cutting teeth. The cutting teeth of each of the first and second shredder blades 40A, 40B are generally aligned so that inner surfaces of adjacent teeth are oriented to form an angle 54 of between eighty (80) degrees to ninety (90) degrees therebetween.

Another preferred method of producing shredder blades includes: transporting sheet metal 68 through a first processing station in a generally continuous fashion; while the sheet metal 68 is moving through the first processing station, stamping the sheet metal 68 to form first and second shredder blades 40A, 40B from the sheet metal 68. The first and second shredder blades each having a major mating surface 48, a sidewall 50 extending generally outwardly therefrom, and a plurality of cutting teeth. The cutting teeth of each of the first and second shredder blades 40A, 40B are generally aligned so that inner surfaces of adjacent teeth are oriented to form an angle 54 of between eighty (80) degrees to ninety (90) degrees therebetween when the first and second shredder blades 40A, 40B are assembled to form a blade pair 52. The method further includes while the first and second shredder blades 40A, 40B are moving through the first processing station, riveting the major mating surface 48 of the first and second shredder blades 40A, 40B together to form a blade pair 52 adapted for use in a shredder. The stamping and riveting both occur in the first processing station to allow first and second shredder blades 40A, 40B to be stamped from sheet metal and riveted together to form the blade pair 52 as part of a generally continuously running manufacturing process for producing a plurality of blade pairs 52 from sheet metal 68 (or any other suitable material).

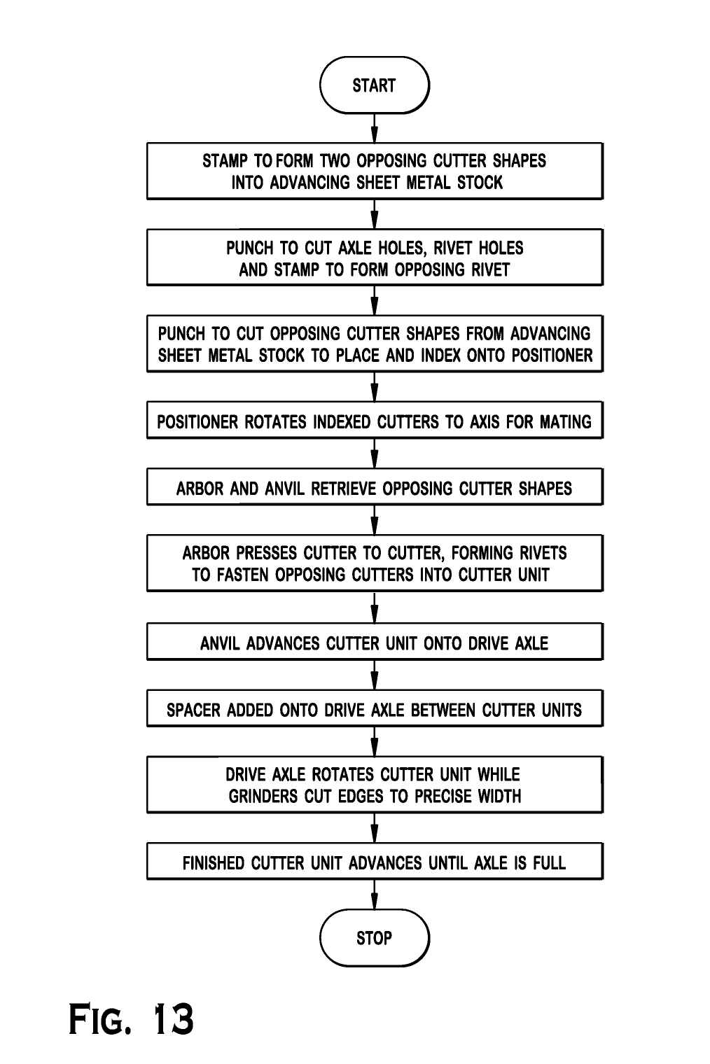

Referring to FIG. 12, one preferred method for producing shredder blade pairs 52 in the processing station of FIGS. 7-11 is described. In the first step, the sheet metal 68 is stamped to form the cutter shapes for the first and second shredder blades 40A, 40B, including the sidewalls 50. In the second step, the sheet metal 68 for the first shredder blade 40A is punched to create the axle hole 44, and stamped to form the three tubes 42, each of which forms a rivet. The sheet metal for the second shredder blade 40B is punched to add the axle hole 44 and the three bores 46 which will accommodate the three tubes 42 of the first shredder blade 40B. In the third step, the sheet metal 68 is punched to cut the first and second shredder blades 40A, 40B from the sheet metal 68, and the shredder blades 40A, 40B are placed into the receiving mold block 76. The mold block 76 rotates to position the first and shredder blades 40A, 40B onto a common axis, and the arbor 84 and anvil 82 receive the two shredder blades. The arbor 84 presses the second shredder blade 42B onto the first shredder blade 42A, and forms rivets which fasten the two shredder blades 42A, 42B into a blade pair 52. The anvil 82 advances the blade pair 52 onto the mandrel 64B, which holds and rotates the blade pair 52 while grinding wheels 86 cut the edges of the blade pair 52 to a precise width. The finished blade pair 52 advances and the mandrel 64B continues to receive and finish blade pairs 52. The steps above repeat until the mandrel 64B has a full complement of finished shredder blade pairs 52, and the mandrel 64B advances to the next assembly station. The finished blade pairs 52 are then removed from the mandrel 64B and assembled onto the shredder axle 64A with the addition of spacers 66.

Referring to FIG. 13, another preferred method for producing shredder blade pairs 52 and mounting them onto the shredder axle 64A is described. In the first step, the sheet metal 68 is stamped to form the cutter shapes for the first and second shredder blades 40A, 40B, including the sidewalls 50. In the second step, the sheet metal 68 for the first shredder blade 40A is punched to create the axle hole 44, and stamped to form the three tubes 42, each of which forms a rivet. The sheet metal for the second shredder blade 40B is punched to add the axle hole 44 and the three bores 46 which will accommodate the three tubes 42 of the first shredder blade 40B. In the third step, the sheet metal 68 is punched to cut the first and second shredder blades 40A, 40B from the sheet metal 68, and the shredder blades 40A, 40B are placed into the receiving mold block 76. The mold block 76 rotates to position the first and shredder blades 40A, 40B onto a common axis, and the arbor 84 and anvil 82 receive the two shredder blades. The arbor 84 presses the second shredder blade 42B onto the first shredder blade 42A, and forms rivets which fasten the two shredder blades 42A, 42B into a blade pair 52. The anvil 82 advances the blade pair 52 onto the shredder axle 64A, and a spacer 66 is added following the blade pair 52. The shredder axle 64A holds and rotates the blade pair 52 while grinding wheels 86 cut the edges of the blade pair 52 to a precise width. The finished blade pair 52 and spacer 66 advance and the shredder axle 64A continues to receive and finish blade pairs 52. Once the shredder axle 64A has a full complement of shredder blade pairs 52, it proceeds to the next assembly station.

It is recognized by those skilled in the art that changes may be made to the above described methods and/or shredder 22 and/or shredder blade pair 52 without departing from the broad inventive concept thereof. It is understood, therefore, that this invention is not limited to the particular embodiments disclosed, but is intended to cover all modifications which are within the spirit and scope of the invention as defined by the above specification, the appended claims and/or shown in the attached drawings.

What is claimed is:

1. A method of producing shredder blades, comprising:
transporting sheet metal through a first processing station in a continuous fashion;
while the sheet metal is moving through the first processing station, stamping the sheet metal to form first and second shredder blades from the sheet metal; and
while the first and second shredder blades are moving through the first processing station, riveting the first and second shredder blades together to form a blade pair adapted for use in a shredder, wherein the stamping and riveting both occur in the first processing station to allow first and second shredder blades to be stamped from sheet metal and riveted together to form the blade pair as part of a continuously running manufacturing process for producing a plurality of blade pairs from sheet metal.

2. The method of claim 1, further comprising the step of forming a shredder axle hole in each of the first and second shredder blades.

3. The method of claim 2, wherein the step of forming further comprises forming the shredder axle hole prior to separating the first and second shredder blades from the sheet metal.

4. The method of claim 3, further comprising the step of forming tubes in the first shredder blade, the tubes being configured to serve as a rivet.

5. The method of claim 4, further comprising the step of forming bores in the second shredder blade that are each adapted to receive one of the tubes from the first shredder blade to facilitate riveting the first and second shredder blades together.

6. The method of claim 5, further comprising the step of positioning the first and second shredder blades to align the bores in the second shredder blade with the tubes in the first shredder blade.

7. The method of claim 6, further comprising inserting the tubes into the bores and bending the tubes to rivet the first and second blades together.

8. The method of claim 7, further comprising placing the blade pair on any one of a mandrel or a shredder axle.

9. A blade pair adapted for use with a shredder, comprising:
first and second shredder blades each having a major mating surface, a sidewall extending generally outwardly therefrom, and a plurality of cutting teeth, wherein the cutting teeth of each of the first and second shredder blades are generally aligned so that inner surfaces of adjacent teeth are oriented to form an angle of between eighty (80) degrees to ninety (90) degrees therebetween.

10. The blade pair of claim 9, wherein an angle between the sidewall and the major mating surface being between one hundred (100) degrees and one hundred twenty (120) degrees,

11. The blade pair of claim 10, wherein the height of the sidewall is between one (1) millimeter and one and a half (1.5) millimeters.

12. The blade pair of claim 9, wherein the cutting teeth of each of the first and second shredder blades are generally aligned so that inner surfaces of adjacent teeth are oriented to form an angle of approximately eighty-six (86) degrees.

13. The blade pair of claim 12, wherein an angle between the sidewall and the major mating surface is approximately one hundred ten and a half (110.5) degrees.

14. The blade pair of claim 13, wherein the height of the sidewall is approximately one point three (1.3) millimeters.

15. A method of producing shredder blades, comprising:
transporting sheet metal through a first processing station in a continuous fashion;
while the sheet metal is moving through the first processing station, stamping the sheet metal to form first and second shredder blades from the sheet metal, the first and second shredder blades each having a major mating surface, a sidewall extending generally outwardly therefrom, and a plurality of cutting teeth, wherein the cutting teeth of each of the first and second shredder blades are generally aligned so that inner surfaces of adjacent teeth are oriented to form an angle of between eighty (80) degrees to ninety (90) degrees therebetween when the first and second shredder blades are assembled to form a blade pair; and
while the first and second shredder blades are moving through the first processing station, riveting the major mating surface of the first and second shredder blades together to form a blade pair adapted for use in a shredder, wherein the stamping and riveting both occur in the first processing station to allow first and second shredder blades to be stamped from sheet metal and riveted together to form the blade pair as part of a continuously running manufacturing process for producing a plurality of blade pairs from sheet metal.

16. The method of claim 15, further comprising the step of forming tubes in the first shredder blade, the tubes being configured to serve as a rivet.

17. The method of claim 16, further comprising the step of forming bores in the second shredder blade that are each adapted to receive one of the tubes from the first shredder blade to facilitate riveting the first and second shredder blades together.

18. The method of claim 17, further comprising inserting the tubes into the bores and bending the tube to rivet the first and second blades together.

19. The method of claim 18, wherein the step of stamping further comprises stamping the first and second shredder blades such that the sidewall and the major mating surface form an angle between one hundred (100) degrees and one hundred twenty (120) degrees,

20. The method of claim 19, wherein the step of stamping further comprises stamping the first and second shredder blades such that the height of the sidewall is between one (1) millimeter and one and a half (1.5) millimeters.

21. The method of claim 20, wherein the step of stamping further comprises stamping the first and second shredder blades such that the sidewall and the major mating surface form the angle of approximately one hundred ten (110) degrees.

22. The method of claim 21, wherein the step of stamping further comprises stamping the first and second shredder blades such that the height of the sidewall is approximately one point three (1.3) millimeters.

23. The method of claim 1, wherein the step of riveting further comprises the first and second shredder blades moving along the same general path as the sheet metal.

24. The method of claim 15, wherein the step of riveting further comprises the first and second shredder blades moving along the same general path as the sheet metal.

25. A method of producing shredder blades, comprising:
transporting material through a first processing station in a continuous fashion;
while the material is moving through the first processing station, forming at least a portion of the material to generate first and second shredder blades from the material; and
while the first and second shredder blades are moving through the first processing station, joining the first and second shredder blades together to form a blade pair adapted for use in a shredder, wherein the forming and joining both occur in the first processing station to allow first and second shredder blades to be formed from material and joined together to form the blade pair as part of a continuously running manufacturing process for producing a plurality of blade pairs from material.
